(19) United States
(12) Patent Application Publication
(10) Pub. No.: US 2013/0321783 A1
(43) Pub. Date: Dec. 5, 2013

(54) VECTOR WAVE RECORDING MEDIUM, AND MULTIPLE RECORDING AND REPRODUCING METHOD

(71) Applicants: Toshio Ando, Kitakyushu-shi (JP); Kazuyoshi Masaki, Chiyoda-ku (JP); Takehiro Shimizu, Kitakyushu-shi (JP); Takashi Fukuda, Tsukuba-shi (JP)

(72) Inventors: Toshio Ando, Kitakyushu-shi (JP); Kazuyoshi Masaki, Chiyoda-ku (JP); Takehiro Shimizu, Kitakyushu-shi (JP); Takashi Fukuda, Tsukuba-shi (JP)

(73) Assignee: NIPPON STEEL & SUMIKIN CHEMICAL CO., LTD., Tokyo (JP)

(21) Appl. No.: 13/984,952

(22) PCT Filed: Mar. 14, 2012
(86) PCT No.: PCT/JP2012/001769

§ 371 Date: Aug. 12, 2013

(30) Foreign Application Priority Data
Mar. 16, 2011 (JP) 2011-057810

(51) Int. Cl. G03H 1/26

(52) U.S. Cl. CPC G03H 1/26
USPC 355/2

(57) ABSTRACT

The present invention pertains to a vector wave recording medium which: has an information recording layer comprising a photo-induced birefringence material; irradiates a recording signal light of a first polarization state, and a recording reference light of a second polarization state that differs to the first polarization state; and carries out vector wave multiplex recording by holography on the information recording layer. The vector wave recording medium is configured in such a manner that ηmin/ηmax=0.1 is satisfied, where, assuming irradiation energy for the recording signal light and the recording reference light is constant, the maximum value of the diffraction efficiency of a playback signal light from diffraction gratings corresponding to information recorded in the information recording layer after the vector wave multiplex recording has been carried out by holography on the information recording layer, is regarded as ηmax, and the minimum value is regarded as ηmin. A vector wave recording medium and a multiplex recording and playback method therefor, which do not require scheduling to be carried out, and which carry no risk of causing a reduction in transfer rates in a recording system, can thus be provided.

### CROSS-REFERENCE TO RELATED APPLICATIONS

This application is a continuation of prior International Application No. PCT/JP2012/001769 filed on Mar. 14, 2012, which is based upon and claims the benefit of priority from Japanese Patent Application No. 2011-057810 filed on Mar. 16, 2011; the entire contents of all of which are incorporated herein by reference.

### TECHNICAL FIELD

The present invention relates to a vector wave recording medium having an information recording layer made from photo-induced birefringence material which causes refractive index anisotropy dependent on the polarization of light to be irradiated thereto and a multiple recording and reproducing method thereof.

### BACKGROUND ART

The writing process for a holographic recording medium is carried out by irradiating a signal beam with an image information and a reference beam to a recording layer so as to record the image information as an interference pattern therein. The reading process for the holographic recording medium is carried out by irradiating the reference beam to the recording layer where the image information is written so as to read the image information as a reproducing signal light out from the interference pattern.

In the holographic data storage, the image information can be recorded, read out as one page and thus at one time per page so that a plurality of pages relating to respective image information can be multiply recorded in the same area of the recording layer of a holographic recording medium. Therefore, the holographic recording technique is a promising candidate for a next-generation optical disc technology with a high data transmission rate and a large capacity which can be substituted for a conventional bit-by-bit data storage technology which is employed in conventional CDs, DVDs and Blu-ray Discs.

On the other hand, a new polarization recording method (retardagraphy), where an image information is recorded as birefringence phase difference (retardation) by using a polarization recording medium having an information recording layer made from photo-induced birefringence material which causes the anisotropy in refractive index dependent on the polarization of light to be irradiated, is proposed (Patent document No. 1). Moreover, a vector wave recording method, where polarization distribution caused by the simultaneous irradiation of a signal beam with an image information and a reference beam with a polarization state different from the signal beam is recorded in the polarization recording medium, is also proposed. In the vector wave recording method, higher density recording will be expected because the holographic recording method and the polarization recording method are combined (Patent document No. 2).

By the way, the recording medium for the holographic recording, that is, the polarization recording can be largely classified into write-once recording medium and rewritable recording medium. As polarization-sensitive compound to be employed for the write-once recording medium and the rewritable recording medium, 9,10-Phenanthrenequinone, azobenzene and the like are widely known.

In the multiple recording using the recording medium to be employed for the write-once recording, a portion of the recording components of the recording medium is optically reacted and changed at the first page recording, another non-reacted portion of the recording components of the recording medium is optically reacted and changed at the second page recording and still another non-reacted portion of the recording components of the recording medium is optically reacted. Then, the intended multiple recording can be carried out by repeating the aforementioned process.

In this manner, since the remaining recording components are decreased as the number of multiple recording is increased, so that the recording sensitivity of the recording medium is deteriorated. Namely, if the recording is carried out at the same irradiation energy of light (beam) for all of the pages, the reproducing signal intensity is decreased at the latter pages, causing the disadvantage for the recording/reproducing system to be used in the aforementioned recording process.

In the multiple recording using the recording medium to be employed for the rewritable recording, a portion of the recording components of the recording medium is optically reacted and changed at the first page recording, some components to be already used in the reaction and change at the first page recording and another non-reacted portion of the recording components of the recording medium are optically reacted and changed at the second page recording, and some components to be already used in the reaction and change at the first page recording and the second page recording and still another non-reacted portion of the recording components of the recording medium are optically reacted. Then, the intended multiple recording can be carried out by repeating the aforementioned process.

In this manner, the already used and recorded components are decreased as the number of multiple recording is increased. Namely, if the recording is carried out at the same irradiation energy of light (beam) for all of the pages, the reproducing signal intensity is decreased at the former pages, which is contradictory to the write-once recording medium, causing the disadvantage for the recording/reproducing system to be used in the aforementioned recording process.

In order to iron out the aforementioned disadvantages, such a method as scheduling technique is employed. In the scheduling method, the multiple recording is carried out by changing the intensity of light to be irradiated per page (grating) through the assumption of the change in reproducing signal intensity, that is, recording sensitivity at the multiple recording process, which allows the reproducing signal intensity per page to be uniform (Patent document No. 3).

Since the recording medium disclosed in Patent document No. 3 is, however, a holographic recording medium and not a vector wave recording medium, much higher density recording cannot be expected. Patent document No. 3 is, moreover, intended to absolutely carry out the scheduling method so that the recording medium disclosed in Patent document No. 3 requires the scheduling technique yet.

When the scheduling method is carried out, the recording process is carried out using a light beam with higher energy for pages whose sensitivities are assumed to be decreased in advance. Although the irradiation energy of the light beam can be represented as the multiplication of the irradiation power and the irradiation period of time of the light beam, the change of the irradiation power per page requires a complicated control system in the recording/reproducing system so that the irradiation period of time is normally changed.

Namely, in order to carry out the recording process using the light beam with the higher energy, the irradiation period of time is required to be extended, causing the deterioration of the data transmission rate in the aforementioned recording/reproducing system.
Patent document No. 1: JP Patent publication No. 2010-020883
Patent document No. 2: JP Patent publication No. 10-340479
Patent document No. 3: JP Patent publication No. 2008-532091

### DISCLOSURE OF THE INVENTION

It is an object of the present invention provide a vector wave recording medium which does not require scheduling technique and may not cause the deterioration of data transmission rate in a recording/reproducing system and a multiple recording/reproducing method thereof.

In order to achieve the object of the present invention, the present invention relates to a vector wave recording medium having an information recording layer made from photo-induced birefringence material, where a recording signal beam with a first polarization state and a recording reference beam with a second polarization state different from the first polarization state are irradiated to the information recording layer so as to carry out holographic vector wave multiple recording, including a ratio (ηmin/ηmax) of 0.1 or more if a minimum diffraction efficiency relating to a reproducing signal beam from each of gratings corresponding to recorded information in the information recording layer is defined as ηmin and a maximum diffraction efficiency relating to a reproducing signal beam from each of gratings corresponding to the recorded information in the information recording layer is defined as ηmax when the vector wave multiple recording is holographically carried out for the information recording layer on a condition that respective irradiation energies of the recording signal beam and the recording reference beam are set to be constant.

Moreover, the present invention relates to a method for multiple recording and reproducing of vector wave recording medium, including the steps of: irradiating a recording signal beam with a first polarization state and a recording reference beam with a second polarization state different from the first polarization state are irradiated for a vector wave recording medium having an information recording layer made from photo-induced birefringence material so as to carry out holographic vector wave multiple recording to the information recording layer on a condition that respective irradiation energies of the recording signal beam and the recording reference beam are set to be constant; and irradiating a reproducing reference beam with the second polarization state for the vector wave recording medium so as to obtain a reproducing signal beam from each of gratings corresponding to recorded information in the information recording layer, wherein a ratio (ηmin/ηmax) of 0.1 or more is satisfied if a minimum diffraction efficiency relating to the reproducing signal beam is defined as ηmin and a maximum diffraction efficiency relating to the reproducing signal beam is defined as ηmax.

Here, “η” is defined as a ratio of I₁/I₀ of the optical intensity I₁ of a reproducing signal beam from each of the gratings for the optical intensity I₀ of the input beam, that is, the recording signal beam and the recording reference beam.

According to the vector wave recording medium and the recording/reproducing method thereof, when the recording signal beam with the first polarization state and the recording reference beam with the second polarization state different from the first polarization state are irradiated to the vector wave recording medium having the information recording layer so as to carry out holographic vector wave multiple recording, the ratio (ηmin/ηmax) of the minimum diffraction efficiency for the maximum diffraction efficiency is set to 0.1 or more on the condition that the respective irradiation energies of the recording signal beam and the recording reference beam are set to be constant.

Namely, the diffraction efficiency of the reproducing signal beam, that is, the intensity of the reproducing signal beam cannot be remarkably decreased in the holographic vector wave multiple recording even though the scheduling process is not carried out on the condition that the respective irradiation energies of the recording signal beam and the recording reference beam are set to be constant. As a result, since the recording process with higher irradiation energy is not required for the pages (gratings) of which sensitivities are assumed to be deteriorated, the irradiation period of time is not required to be extended, thereby suppressing the deterioration of the data transmission rate in the recording system.

In an embodiment of the present invention, the photo-induced birefringence material contains an optical radical generating agent and a polymer matrix. Moreover, the optical radical generating agent includes an intramolecular cleavage type radical generating agent. Furthermore, the intramolecular cleavage type radical generating agent includes at least one of α-aminoacetophenone compound and oxime ester compound.

According to the present invention can be provided a vector wave recording medium which does not require scheduling technique and may not cause the deterioration of data transmission rate in a recording/reproducing system and a multiple recording/reproducing method thereof.

### BRIEF DESCRIPTION OF THE DRAWINGS

FIG. 1 is a perspective view illustrating the schematic structure of a vector wave recording medium according to an embodiment.

FIG. 2 is a structural view schematically illustrating an optical system for carrying out holographic vector wave multiple recording.

FIG. 3 is a structural view schematically illustrating an optical system for carrying out reading out of the recorded information after the holographic vector wave multiple recording is carried out.

FIG. 4 is a graph illustrating a relative diffracted intensity η/ηmax from a grating after holographic vector wave multiple recording is carried out in Examples.

FIG. 5 is a graph illustrating a relative diffracted intensity η/ηmax from another grating after holographic vector wave multiple recording is carried out in Examples.

FIG. 6 is a graph illustrating a relative diffracted intensity η/ηmax from still another grating after holographic vector wave multiple recording is carried out in Examples.

FIG. 7 is a graph illustrating a relative diffracted intensity η/ηmax from a further grating after holographic vector wave multiple recording is carried out in Examples.

FIG. 8 is a graph illustrating a relative diffracted intensity η/ηmax from a still further grating after holographic vector wave multiple recording is carried out in Examples.

FIG. 9 is a graph illustrating a relative diffracted intensity η/ηmax from another grating after holographic vector wave multiple recording is carried out in Examples.

FIG. 10 is a graph illustrating a relative diffracted intensity η/ηmax from still another grating after holographic vector wave multiple recording is carried out in Examples.

FIG. 11 is a graph illustrating a relative diffracted intensity η/ηmax from a further grating after holographic vector wave multiple recording is carried out in Examples.

### MODE FOR CARRYING OUT THE INVENTION

Hereinafter, embodiments of the present invention will be described with reference to drawings.

(Vector Wave Recording Medium)

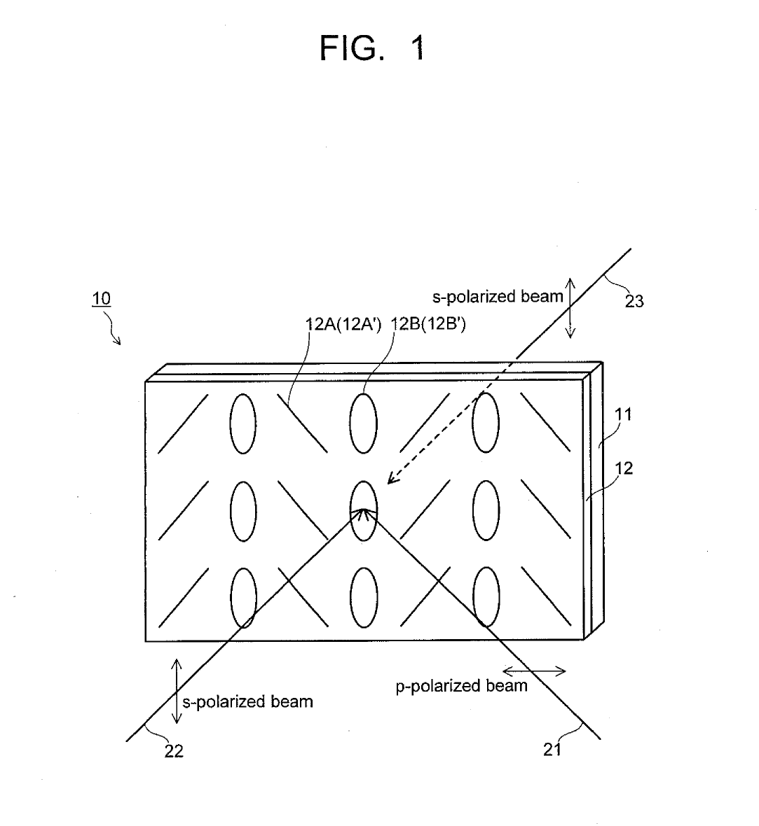

First of all, one embodiment of the vector wave recording medium will be described. FIG. 1 is a perspective view illustrating the schematic structure of the vector wave recording medium according to this embodiment. As illustrated in FIG. 1, the vector wave recording medium 10 in this embodiment includes a transparent substrate 11 and an information recording layer 12 made from photo-induced birefringence material which is formed on the transparent substrate 11.

The transparent substrate 11 may be made from glass, resin, for example, preferably from resin in view of moldability and cost. As the resin can be exemplified polycarbonate resin, acrylic resin, epoxy resin, polystyrene resin, acrylonitrile-styrene copolymer, polyethylene resin, polypropylene resin, silicone resin, fluorine resin, ABS resin, urethane resin. Among the exemplified resins, polycarbonate resin and acrylic resin are preferable in view of moldability, optical property and cost.

Moreover, micro-processing may be carried out on the surface of the transparent substrate 11 if needed. Furthermore, hard coat-processing may be carried out on the surface of the transparent substrate 11 using UV curing resin. In addition, antireflection-processing may be carried out on the surface of the transparent substrate 11.

The transparent substrate 11 may be made from ceramic material only if the recording/reproducing process, which will be described below, cannot be affected by the use of the ceramic material.

The thickness of the transparent substrate 11 is appropriately set so as not to affect the recording/reproducing process for the vector wave recording medium 10, that is, the information recording layer 12.

The information recording layer 12 contains a polymer matrix and an optical radical generating agent. Concretely, the polymer matrix and the optical radical generating agent are dissolved in a solvent, coated and dried on the transparent substrate 11 so as to form the information recording layer 12. Alternatively, the polymer matrix and the optical radical generating agent are melted, kneaded and molded so as to form the information recording layer 12.

As the polymer matrix can be, not limited to, exemplified acrylic resin such as polyacrylic ester, polyvinyl resin, polyorefin resin, polyacetal resin, cellulosic resin, polyurethane resin, polyamide resin, polyester resin, polycarbonate resin, phenoxy resin, phenol resin, epoxy resin, polyimide resin and various elastomers. The exemplified resins may be employed in such a manner as single resin, a mixture of two or more resins or a copolymer. It is desired that the polymer matrix is optically transparent and small birefringent.

The optical radical generating agent is, only if generating radical species through light irradiation, not limited, but may be one or more of compounds commercially available. The optical radical generating agent can be classified into intramolecular cleavage type radical generating agent and hydrogen extraction type radical generating agent. Among them, the former intramolecular cleavage type radical generating agent is preferable for the present invention (present embodiment). As the intramolecular cleavage type radical generating agent can be exemplified α-aminoacetophenone compounds and oxime ester compounds.

One or more of the α-aminoacetophenone compounds may be employed in such a manner as a single compound or a mixture of two or more of the compounds. Concretely, as the α-aminoacetophenone compound can be exemplified as follows.

2-dimethylamino-2-methyl-1-phenylpropane-1-one, 2-diethylamine-2-methyl-1-phenylpropane-1-one, 2-methyl-2-morpholino-1-phenylpropane-1-one, 2-diethylamino-2-methyl-1-(4-methylphenyl)propane-1-one, 2-diethylamino-1-(4-ethylphenyl)propane-2-methylpropane-1-one, 2-diethylamino-1-(4-isopropylphenyl)-2-methylpropane-1-one, 2-diethylamino-2-methyl-1-(4-ethylthiophenyl)propane-1-one, 1-(4-butylphenyl)-2-dimethylamino-2-methylpropane-1-one, 2-dimethylamino-1-(4-methoxyphenyl)-2-methylpropane-1-one, 2-dimethylamino-2-methyl-1-(4-methylthiophenyl)-2-morpholinopropane-1-one (IRGACURE 907), 2-benzyl-2-dimethylamino-1-(4-morpholinophenyl)butane-1-one (IRGACURE 369), 2-benzyl-2-dimethylamino-1-(4-dimethylaminophenyl)butane-1-on e, 2-dimethylamino-2-[(4-methylphenyl)methyl]-1-(4-morpholino)butane-1-one (IRGACURE 379) may be exemplified.

One or more of the oxime compounds may be employed in such a manner as a single compound or a mixture of two or more of the compounds. Concretely, as the oxime compound can be exemplified as follows.

3-benzoyloxyiminobutane-2-one, 3-acetoxyiminobutane-2-one, 3-propionyloxyiminobutane-2-one, 2-acetoxyimiopentane-3-one, 2-acetoxyimio-1-phenylpropane-1-one, 2-benzoyloxyimino-1-phenylpropane-1-one, 3-p-toluenesulfonyloxyimino-1-phenylpropane-1-one, 2-ethoxycarbonyloxyimino-1-phenylpropane-1-one, 1-(4-phenylthiophenyl-2-benzoyloxyiminooctane-1-one(IRGACURE OXE01), 1-[9-ethyl-6-(2-methylbenzoyl)carbazole-3-yl]-1-acetoxyiminoe thane) (IRGACURE OXE02) may be exemplified.

In this embodiment, the transparent 11 is provided, but may be omitted only if the polymer matrix is made from thermosetting resin such as phenol resin or epoxy resin or engineering plastic material such as polycarbonate so as to strength itself.

The thickness of the information recording layer 12 can be preferably set within a range of 1 to 3000 μm. In this case, the light transmittance of the information recording layer 12 can be enhanced within a recording wavelength range of 350 nm to 800 nm so that the information recording layer 12 can be sufficiently recorded by a recording signal beam and a recording reference beam with respective lower energies so as to enhance the energy efficiency thereof.

Micro-processing, hard coat-processing using UV curing resin, etc., or antireflection processing may be carried out for the surface of the information recording layer 12.

In the present invention, if the minimum diffraction efficiency relating to the reproducing signal beam from each of the gratings corresponding to the recorded information is defined as ηmin and the maximum diffraction efficiency relating to the reproducing signal beam from each of the gratings corresponding to the recorded information is defined as ηmax when the vector wave multiple recording is holographically carried out, it is required that the ratio (ηmin/ηmax) is set to 0.1 or more, preferably 0.2 or more, more preferably 0.3 or more on the condition that the respective irradiation energies of the recording signal beam and the recording reference beam are set to be constant.

In this manner, if the respective irradiation energies of the recording signal beam and the recording reference beam are set to be constant without scheduling process, the diffraction efficiency of the reproducing signal beam, that is, the intensity of the reproducing signal beam cannot be remarkably decreased in the vector wave multiple recording process. As a result, a recording process with higher irradiation energy is not required for pages of which the sensitivities are assumed to be decreased so that the period of time in the irradiation of the recording signal beam and the like for higher irradiation energy can be shortened and the deterioration of the data transmission rate in the corresponding recording/reproducing system can be suppressed.

Here, the aforementioned requirement for the ratio (ηmin/ηmax) can be realized by the use of one or more of the aforementioned materials of the information recording layer 12. Particularly, if one or more of the α-aminoacetophenone compounds and oxime ester compounds, which are classified into the intramolecular cleavage type photo radical generating agent, are employed as the photo radical polymerization initiator, the aforementioned requirement for the ratio (ηmin/ηmax) can be easily realized.

Ideally, the upper limited value of the ratio (ηmin/ηmax) is 1, but about 0.7 at present only if the aforementioned materials are employed.

In this embodiment, the transparent vector wave recording medium 10 has been explained, as illustrated in FIG. 1, but a reflective vector wave recording medium may be employed by providing an reflective layer on the surface opposite to the surface on which the information recording layer 12 is formed.

(Holographic Vector Wave Multiple Recording and Reproducing)

Then, the holographic vector wave multiple recording and reproducing will be schematically explained referring to FIG. 1.

In the recording for the vector wave recording medium 10, as illustrated in FIG. 1, a recording signal beam 21 and a recording reference beam 22, which are coherent one another, are simultaneously irradiated to the same area of the information recording medium 12.

Supposed that the recording signal beam 21 is a p-polarized beam and the recording reference beam 22 is a s-polarized beam, for example, the polarization direction in the same area of the information recording layer 12 is spatially and periodically modulated so that linearly polarized portions 12A which are inclined and crossed by ±45 degrees and circularly polarized portions 12B are alternatively and periodically are formed.

In this case, the beam intensity for the information recording layer 12 is set to be constant, but birefringence is caused in the information recording layer 12 commensurate with the polarization direction formed through the spatial and periodical modulation because the information recording layer 12 is made from photo-induced birefringence material. In the linearly polarized portions 12A, as a result, the respective birefringence gratings with the respective different absorption ratios and refractive indexes, which are distributed along the polarization direction of ±45 degrees, are formed as holograms.

Then, the Bragg condition of the vector wave recording medium 10, that is, the information recording layer 12 is changed, and the recording signal beam 21 and the recording reference beam 22 are irradiated on the same area, which is already recorded, of the information recording layer 12 in such a manner as described above, on the condition that the respective irradiation energies of the recording signal beam 21 and the recording reference beam 22 are set to be constant. In this case, the polarization direction in the same area of the information recording layer 12 is spatially and periodically modulated so that linearly polarized portions 12A′ which are inclined and crossed by ±45 degrees and circularly polarized portions 12B′ are alternatively and periodically are formed.

In this case, the beam intensity for the information recording layer 12 is set to be constant, but the portions of the information recording layer 12 along the polarization directions are optically excited in comparison with other portions thereof not along the polarization directions. In the linearly polarized portions 12A′, as a result, the respective birefringence gratings with the respective different absorption ratios and refractive indexes, which are distributed along the polarization direction of ±45 degrees, are formed as holograms.

In this manner, if the recording signal beam 21 and the recording reference beam 22 are subsequently irradiated while the Bragg condition of the information recording layer 12 is subsequently changed, on the condition that the respective irradiation energies of the recording signal beam 21 and the recording reference beam 22 are set to be constant, each of the gratings of the information recording layer 12 can function as recording source, so that the intended holographic vector wave multiple recording can be conducted for the information recording layer 12.

Here, the polarization conditions of the recording signal beam 21 and the recording reference beam 22 are set to the p-polarized beam and s-polarized beam, respectively, for the gratings of the information recording layer 12, but may be changed to other polarized beams, respectively.

Then, a reproducing reference beam 23 of s-polarized state is irradiated to the information recording layer 12 which is already multiply and holographically recorded by means of vector wave multiple recording from the front side or the back side of the information recording layer 12. In this time, respective diffraction beams can be obtained from the corresponding to the gratings of the information recording layer 12 which are holographically recorded by means of vector wave multiple recording. The polarization condition of each of the diffraction beams is shifted from the reproducing reference beam 23 by 90 degrees so that each of the diffraction beams becomes a p-polarized beam. In this manner, the information recording layer 12, that is, vector wave recording medium can be reproduced (read out) by irradiating the reproducing reference beam 23 per grating in the information recording layer 12 which is holographically recorded by means of vector wave multiple recording.

In this embodiment, the principle of recording/reproducing technique for the transparent vector wave recording medium has been explained because the vector wave recording medium 10 illustrated in FIG. 1 is configured as the transparent vector wave recording medium. However, the principle of recording/reproducing technique for a reflective vector wave recording medium can be conducted in the same manner as the principle of recording/reproducing technique for the transparent vector wave recording medium expect that the reproducing reference beam 23 is irradiated to the information recording layer 12 from the same side of the recording signal beam 21 and the recording reference beam 22.

(Concrete Embodiment of Holographic Vector Wave Multiple Recording and Reproducing)

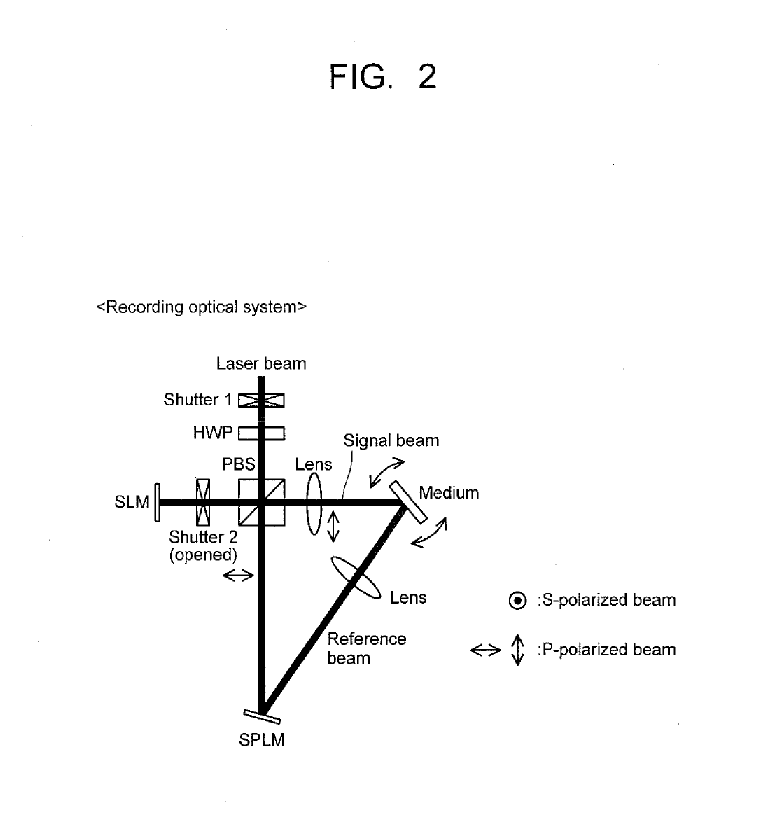

FIG. 2 is a structural view schematically illustrating an optical system for carrying out the holographic vector wave multiple recording and FIG. 3 is a structural view schematically illustrating an optical system for carrying out the reading out of the recorded information after the holographic vector wave multiple recording is carried out.

In order to carry out the holographic vector wave multiple recording, for example, the optical system as illustrated in FIG. 2 is employed. In this optical system, the laser beam is passed through the HWP (half-wavelength plate) and divided into two laser beams at the PBS (polarization beam splitter). Then, one of the divided laser beams is passed through the shutter 2 as the recording signal beam, reflected at the SLM (spatial light modulator), passed through the PBS and irradiated to the vector wave recording medium. In this case, the optical beam reflected at the SLM contains a p-polarized beam and a s-polarized beam to be intermingled. However, since only the p-polarized beam of the reflected beams can be passed through the PBS, the p-polarized beam is irradiated as the recording signal beam to the recording medium via the lens.

The other of the divided laser beams is reflected as the recording reference beam at the SPLM (spatial polarization light modulator) and irradiated to the vector wave recording medium via the lens. In this case, the polarization state of the recording reference beam is controlled so as to be orthogonal to the polarization state of the recording signal beam, that is, the s-polarized beam. In this case, the polarization direction in the information recording layer 12 is spatially and periodically modulated so that linearly polarized portions which are inclined and crossed by ±45 degrees and circularly polarized portions are alternatively and periodically are formed, as described above. As a result, the respective birefringence gratings with the respective different absorption ratios and refractive indexes, which are distributed along the polarization direction of ±45 degrees, are formed as holograms.

Then, the angle of the vector wave recording medium is changed by the use of the control device (not shown) of the optical system illustrated in FIG. 2 so that the intended holographic vector wave multiple recording is carried out for the information recording medium, that is, the vector wave recording medium through the aforementioned process.

In the reading out (reproducing) of the information from the vector wave recording medium, that is, the information recording layer for which the holographic vector wave multiple recording is carried out, the optical system as illustrated in FIG. 3 and as configured such that an imaging optical system, a polarizing plate and an imager, which are utilized for forming an image from the reproducing beam (diffraction beam) passed through the recording medium, are added to the optical system illustrated in FIG. 2 to be a fundamental optical system may be employed.

In the reproducing process using the optical system illustrated in FIG. 3, the laser beam passed through the shutter 1, the HWP and the PBS is reflected at the SPLM while the shutter 2 is closed so as to form a reproducing beam with s-polarized state which is to be irradiated to the vector wave recording medium.

In the reproducing process, the respective diffraction beams can be obtained from the corresponding diffraction gratings to which the holographic vector wave multiple recording is carried out. In this case, each of the diffraction beams is shifted in angle by 90 degrees to be a p-polarized beam. By changing the angle of the vector wave recording medium by the control device (not shown) and irradiating the reproducing reference beam with the s-polarized state per diffraction grating to which the holographic vector wave multiple recording is carried out in the same manner as described above, the reproducing (reading out) for the vector wave recording medium, that is, the information recording layer, to which the holographic vector wave multiple recording is carried out, can be carried out.

Here, the diffraction beam is imaged at the imaging lens and the optical beam with p-polarized state thereof is passed only through the polarizing plate, input into the imager and analyzed in recording information.

### EXAMPLES

### Example 1

The recording material precursor made from 10.0 parts by mass of IRGACURE 379 (made by BASF) as an optical radical generating agent, 40.9 parts by mass of dicyclohexylmethane-4,4′-diisocyanate (made by TOKYO CHEMICAL INDUSTORY CO., LTD.) and 49.1 parts by mass of pentaerythritol propoxylate (mean molecular weight 629: made by Aldrich) as a polymer matrix forming material, and 0.07 part by mass of dibutyl tin dilaurate as a curing catalyst were blended.

The recording material precursor was infiltrated into the space formed between two glass substrates (30 mm×30 mm, thickness: 1.1 mm) which are bonded with one another via a silicon film spacer (thickness; 1.0 mm), and heated for 3 hours at 55° C. under the atmosphere of nitrogen. As a result, a vector wave recording medium A where an information recording layer made of photo-induced birefringence material is formed between the glass substrates was formed.

### Example 2

A vector wave recording medium B was formed in the same manner as Example 1 except that 49.7 parts by mass of dicyclohexylmethane-4,4′-diisocyanate (made by TOKYO CHEMICAL INDUSTORY CO., LTD.) and 40.3 parts by mass of pentaerythritol propoxylate (mean molecular weight 426: made by Aldrich) were employed as the polymer matrix forming material.

### Example 3

A vector wave recording medium C was formed in the same manner as Example 1 except that 5.0 parts by mass of IRGACURE 379 (made by BASF) was employed as the optical radical generating agent, and 43.2 parts by mass of dicyclohexylmethane-4,4′-diisocyanate (made by TOKYO CHEMICAL INDUSTORY CO., LTD.) and 51.8 parts by mass of pentaerythritol propoxylate (mean molecular weight 629: made by Aldrich) were employed as the polymer matrix forming material.

### Example 4

A vector wave recording medium D was formed in the same manner as Example 1 except that 15.0 parts by mass of IRGACURE 379 (made by BASF) was employed as the optical radical generating agent, and 38.7 parts by mass of dicyclohexylmethane-4,4′-diisocyanate (made by TOKYO CHEMICAL INDUSTORY CO., LTD.) and 46.3 parts by mass of pentaerythritol propoxylate (mean molecular weight 629: made by Aldrich) were employed as the polymer matrix forming material.

### Example 5

A vector wave recording medium E was formed in the same manner as Example 1 except that 10.0 parts by mass of IRGACURE OXE01 (made by BASF) was employed as the optical radical generating agent, and 40.9 parts by mass of dicyclohexylmethane-4,4′-diisocyanate (made by TOKYO CHEMICAL INDUSTORY CO., LTD.) and 49.1 parts by mass of pentaerythritol propoxylate (mean molecular weight 629: made by Aldrich) were employed as the polymer matrix forming material.

### Comparative Example 1

The recording material precursor made from 1.0 part by mass of 9,10-Phenanthrenequinone (made by TOKYO CHEMICAL INDUSTORY CO., LTD.) as a polarization sensitive compound, 98.6 parts by mass of methyl methacrylate (made by Wako Pure Chemical Industries Ltd.) as a thermopolymerization monomer and 0.4 part by mass of 2,2′-azobis (isobutylnitrile) as thermopolymerization initiator were blended. The recording material precursor was heated for 2 hours at 60° C. and introduced into the space formed between two glass substrates (30 mm×30 mm, thickness: 1.1 mm) which are bonded with one another via a silicon film spacer (thickness; 1.0 mm) which is cut out in a form of depression, and heated for 6 hours at 60° C. Then, the glass substrates were released to form a recording medium F.

<Recording and Reproducing Process>

The recording and reproducing process were carried out using the optical systems as illustrated in FIGS. 2 and 3 and following the aforementioned recording and reproducing processes. In the recording optical system illustrated in FIG. 2, a semiconductor laser with an oscillating wavelength of 405 nm in a state of single mode was employed as the recording light source. Moreover, the SLM was set such that all pixels were totally reflected and the PSLM was set such that all pixels were shifted in polarization by 90 degrees. In the optical system, furthermore, a He—Ne laser with an oscillating wavelength of 633 nm was employed as the reproducing light source.

<Measurement Result>

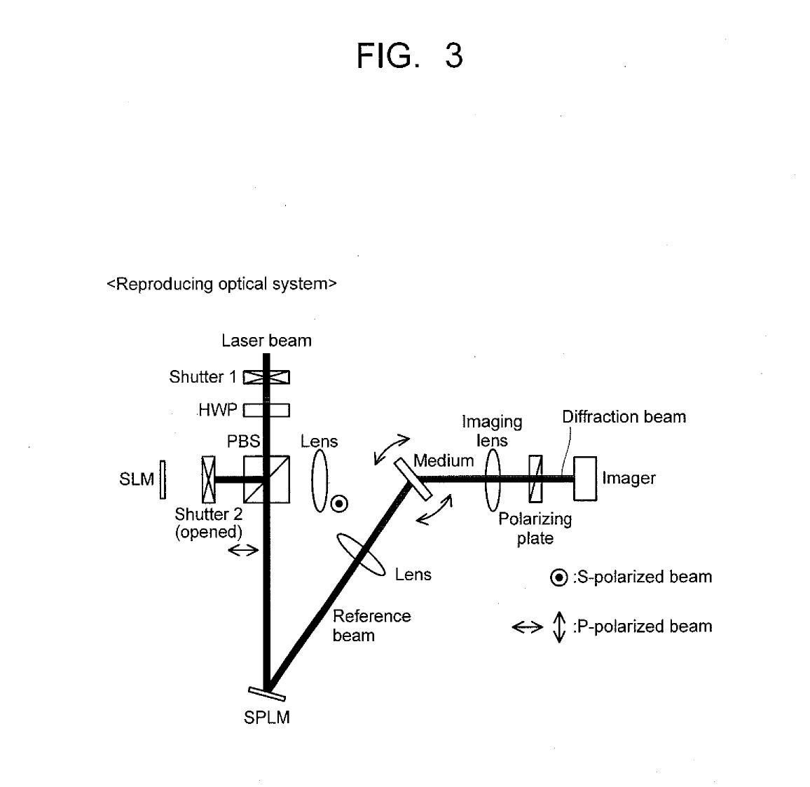

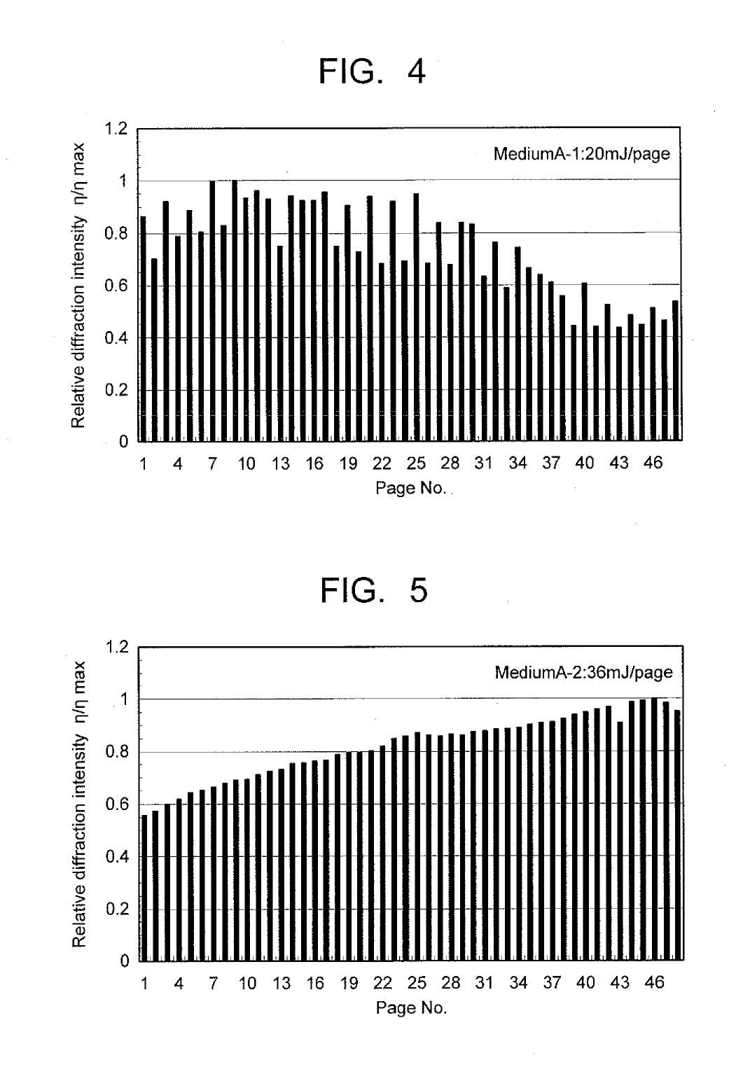

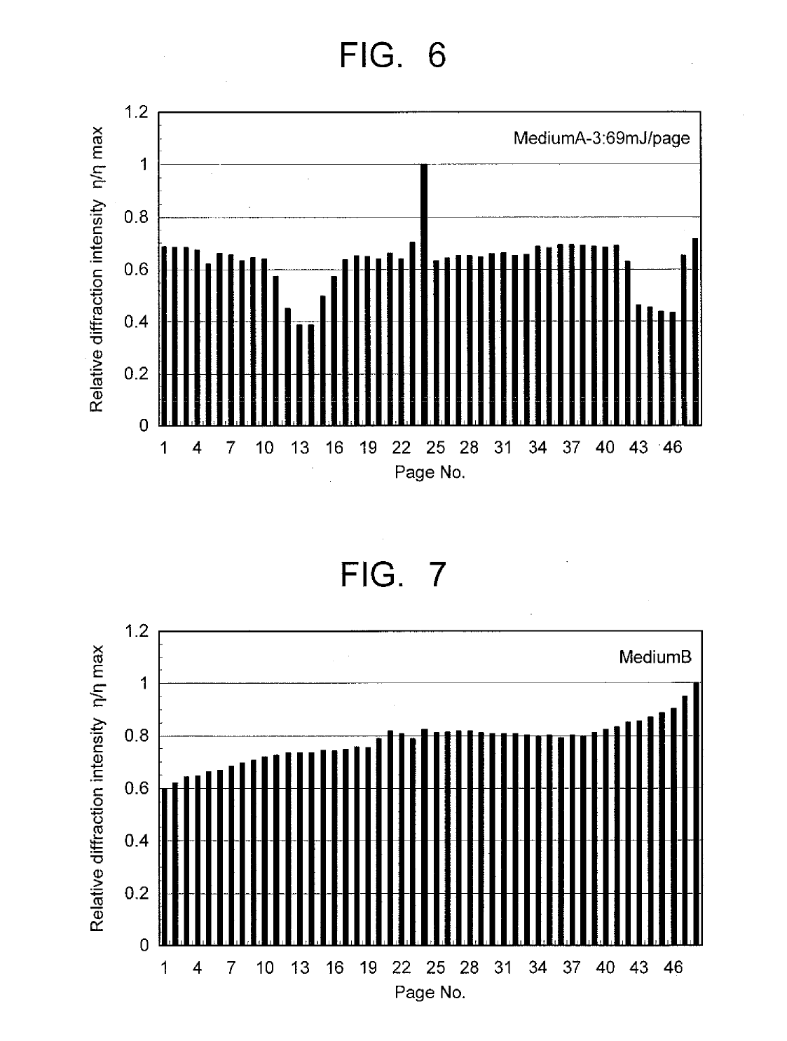

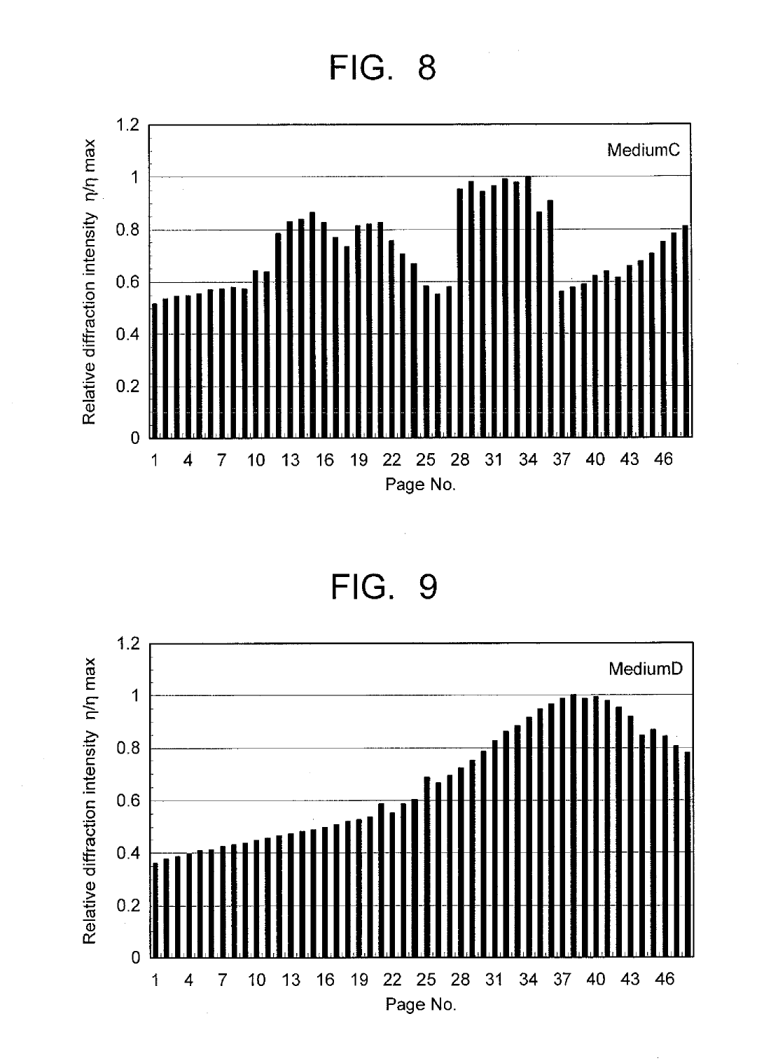

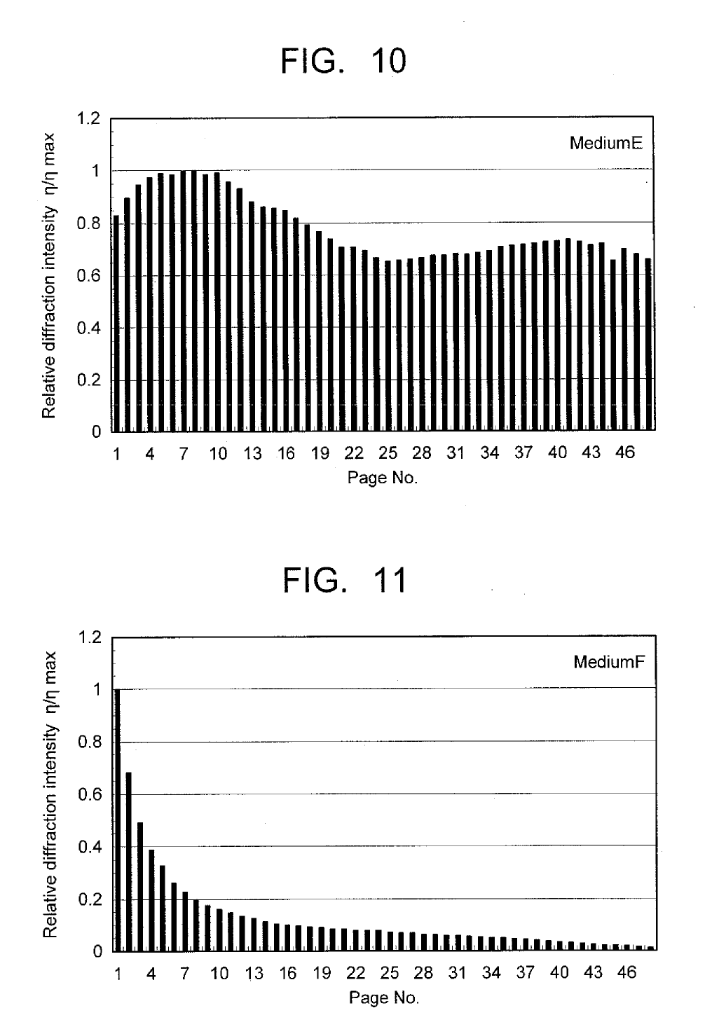

FIGS. 4 to 11 are graphs illustrating each relative diffracted intensity 71/ηmax from the corresponding grating after 48 multiple recording as the holographic vector wave multiple recording is carried out for the recording media A to F, respectively under the condition of no scheduling process (namely, the holographic vector wave multiple recording was carried out under the condition that the irradiation energies of the recording signal beam and the recording reference beam were set to be constant per each grating corresponding to recording information by changing the Bragg condition of each of the recording media A to F). Then, the ratio (ηmin/ηmax) obtained from the data of each of the graphs of relative diffracted intensity ηmin/ηmax was listed in Table 1. Here, FIGS. 4 to 6 show the cases where the energies of the recording signal beam and the recording reference beam were changed in the recording medium A. However, the energies of the recording signal beam and the recording reference beam at 48 multiple recording were set to be constant through all of 48 times recording processes.

TABLE 1

| Recording | Exposure amount per page | |
|---|---|---|
| medium | (mJ/cm²) | η min/η max |
| A-1 | 20 | 0.440 |
| A-2 | 36 | 0.558 |
| A-3 | 69 | 0.388 |
| B | 73.2 | 0.599 |
| C | 72 | 0.518 |
| D | 48 | 0.365 |
| E | 27.5 | 0.652 |
| F(Comparison) | 154.5 | 0.012 |

As is apparent from FIGS. 4 to 11 and Table 1, the ratio (ηmin/ηmax) of each of the recording media A to F was 0.3 or more and thus the scheduling process is not essentially required at the 48 multiple recording. In contrast, the ratio (ηmin/ηmax) of the recording medium F was only 0.012 which was relatively small and thus the scheduling process is required at the 48 multiple recording.

Moreover, as is apparent from FIGS. 4 to 6 and A-1, A-2, A-3 in Table 1, the ratio (ηmin/ηmax) of the recording medium A was maintained 0.3 or more even though the irradiation energies of the recording signal beam and the recording reference beam were changed, which means that the change in irradiation energy of the recording signal beam and the recording reference beam does not affect the requirement of the scheduling process.

Although the present invention was described in detail with reference to the above examples, this invention is not limited to the above disclosure and every kind of variation and modification may be made without departing from the scope of the present invention.

(Description Related to Result of Contact Research by National Government, etc.)

Patent application applied to “Strategic innovation creating promotion” and “Practical use study of three-dimensional vector wave memory technique” under Industrial-university co-operated innovation of Japan Science and Technology Agency, 2012 and to Industrial Technology Enhancement Act, Article 19

1. A vector wave recording medium having an information recording layer made from photo-induced birefringence material, where a recording signal beam with a first polarization state and a recording reference beam with a second polarization state different from the first polarization state are irradiated to the information recording layer so as to carry out holographic vector wave multiple recording,
a ratio (ηmin/ηmax) of 0.1 or more if a minimum diffraction efficiency relating to a reproducing signal beam from each of gratings corresponding to recorded information in the information recording layer is defined as min and a maximum diffraction efficiency relating to a reproducing signal beam from each of gratings corresponding to the recorded information in the information recording layer is defined as wax when the vector wave multiple recording is holographically carried out for the information recording layer on a condition that respective irradiation energies of the recording signal beam and the recording reference beam are set to be constant.

2. The vector wave recording medium as set forth in claim 1,
wherein the photo-induced birefringence material comprises an optical radical generating agent and a polymer matrix.

3. The vector wave recording medium as set forth in claim 2,
wherein the optical radical generating agent comprises an intramolecular cleavage type radical generating agent.

4. The vector wave recording medium as set forth in claim 3,
wherein the intramolecular cleavage type radical generating agent comprises at least one of α-aminoacetophenone compound and oxime ester compound.

5. The vector wave recording medium as set forth in claim 1,
wherein the first polarization state comprises one of a p-polarization state and a s-polarization state and the second polarization state comprises the other of the p-polarization state and the s-polarization state.

6. The vector wave recording medium as set forth in claim 1,
wherein the vector wave multiple recording for the information recording layer is carried out by changing a Bragg condition of the information recording layer.

7. A method for multiple recording and reproducing of vector wave recording medium, comprising the steps of:
irradiating a recording signal beam with a first polarization state and a recording reference beam with a second polarization state different from the first polarization state are irradiated for a vector wave recording medium having an information recording layer made from photo-induced birefringence material so as to carry out holographic vector wave multiple recording to the information recording layer on a condition that respective irradiation energies of the recording signal beam and the recording reference beam are set to be constant; and
irradiating a reproducing reference beam with the second polarization state for the vector wave recording medium so as to obtain a reproducing signal beam from each of gratings corresponding to recorded information in the information recording layer,
wherein a ratio (ηmin/ηmax) of 0.1 or more is satisfied if a minimum diffraction efficiency relating to the reproducing signal beam is defined as win and a maximum diffraction efficiency relating to the reproducing signal beam is defined as wax.

8. The multiple recording and reproducing method as set forth in claim 7,
wherein the photo-induced birefringence material comprises an optical radical generating agent and a polymer matrix.

9. The multiple recording and reproducing method as set forth in claim 8,
wherein the optical radical generating agent comprises an intramolecular cleavage type radical generating agent.

10. The multiple recording and reproducing method as set forth in claim 9,
wherein the intramolecular cleavage type radical generating agent comprises at least one of α-aminoacetophenone compound and oxime ester compound.

11. The multiple recording and reproducing method as set forth in claim 7,
wherein the first polarization state comprises one of a p-polarization state and a s-polarization state and the second polarization state comprises the other of the p-polarization state and the s-polarization state.

12. The multiple recording and reproducing method as set forth in claim 7,
wherein the vector wave multiple recording for the information recording layer is carried out by changing a Bragg condition of the information recording layer.
